(19) United States
(12) Patent Application Publication
(10) Pub. No.: US 2015/0210264 A1
(43) Pub. Date: Jul. 30, 2015

(54) REVERSE VEHICLE SPEED CONTROL USING ONLY THE BRAKE PEDAL

(71) Applicant: Continental Automotive Systems, Inc., Auburn Hills, MI (US)

(72) Inventor: David Leslie Agnew, Clarkston, MI (US)

(21) Appl. No.: 14/603,412

(22) Filed: Jan. 23, 2015

Related U.S. Application Data
(60) Provisional application No. 61/933,039, filed on Jan. 29, 2014.

(51) Int. Cl. B60W 10/10; B60W 10/18; B60W 30/18; G05G 1/44

(52) U.S. Cl. CPC B60W 10/10; G05G 1/44; B60W 10/18; B60W 30/18009; B60W 2510/10; B60W 2510/18; B60W 2710/10; B60W 2710/18

(57) ABSTRACT

A vehicle operating system is disclosed that includes an accelerator pedal for generating an input proportional to a desired acceleration of a vehicle when the vehicle is in at least one of a plurality of forward gears and a brake pedal for generating an input for controlling application of vehicle brakes of the vehicle. The brake pedal is configured to generate a single input for controlling both acceleration of the vehicle and application of the vehicle brakes when the vehicle is in a reverse gear.

### CROSS REFERENCE TO RELATED APPLICATION

This application claims priority to U.S. Provisional Application No. 61/933,039 filed on Jan. 29, 2014.

### TECHNICAL FIELD

The present disclosure relates to automotive vehicles, and more particularly to a reverse driver assistance system for automotive vehicles.

### BACKGROUND

Advancements in sensor and vehicle technology have led to the ability to improve safety systems for vehicles. Arrangements and methods for detecting and avoiding collisions are increasingly improving vehicle performance and ease of operation. Such driver assistance systems can use sensors located on the vehicle to detect an oncoming collision. The systems may warn the driver of various driving situations to prevent or minimize collisions. Additionally, sensors and cameras are also used to alert the driver of possible obstacles when the vehicle is traveling in reverse.

Maneuvering a vehicle in a reverse direction is relatively infrequent and therefore many drivers are not as proficient as desirable. Accordingly, a system that aids a driver when maneuvering in a reverse direction may be useful.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A disclosed vehicle operating system includes a controller for controlling input from an accelerator pedal generating an input proportional to a desired acceleration of a vehicle when the vehicle is in at least one of a plurality of forward gears and a brake pedal for generating an input for controlling application of vehicle brakes of the vehicle. The controller further provides for the brake pedal to generate a single input for controlling both acceleration of the vehicle and application of the vehicle brakes when the vehicle is in a reverse gear.

A disclosed method of controlling a vehicle in reverse gear includes the step of braking the vehicle when the driver compresses a first pedal in the vehicle when the vehicle is in one of a plurality of forward gears and accelerating the vehicle when the driver compresses a second pedal in the vehicle when the vehicle is in one of the plurality of forward gears. When in a reverse gear, braking the vehicle is provided when the driver compresses one of the first and the second pedal in the vehicle and accelerating the vehicle is provided when the driver releases the same one of the first and the second pedal of the vehicle when the vehicle is in the reverse gear.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

The present disclosure will become more fully understood from the detailed description and the accompanying drawings, wherein:

FIG. 1 is a schematic illustration of a top view of a vehicle utilizing a back-up system of the present invention.

### DETAILED DESCRIPTION

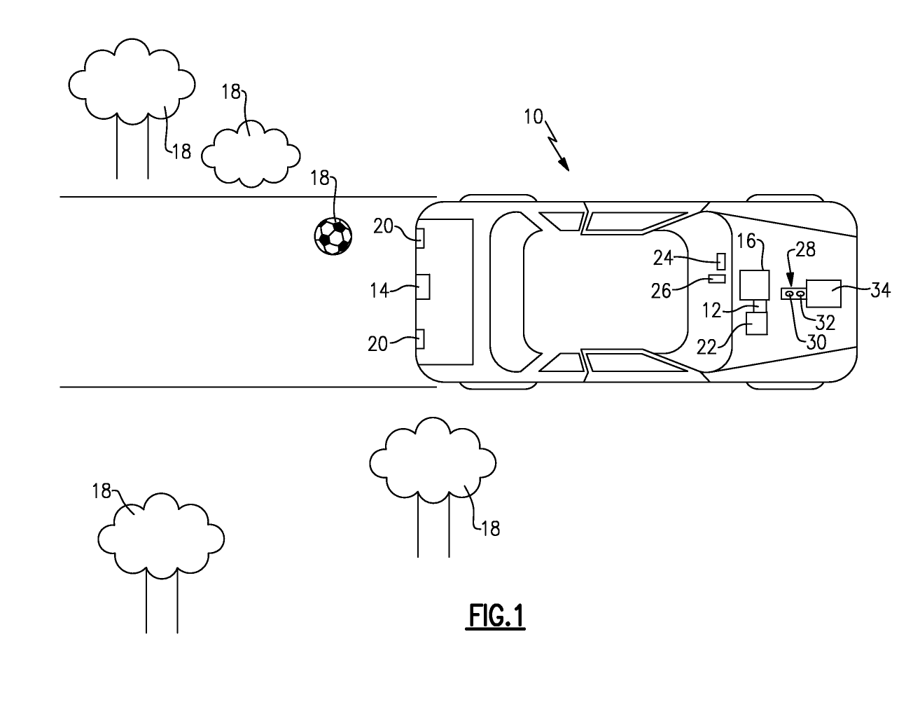

The following description is merely exemplary in nature and is in no way intended to limit the disclosure, its application, or uses. For purposes of clarity, the same reference numbers will be used in the drawings to identify similar elements. FIG. 1 schematically illustrates a vehicle 10 including an engine 34 and a transmission 28 including forward gears 30 and reverse gears 32. The vehicle 10 further includes a driver assistance system, in particular a reverse collision avoidance system 12, as explained in further detail below. Throughout the application the relative directions of forward and rear are in reference to the direction which an operator for the vehicle 10 would primarily be facing when operating the vehicle 10.

When the vehicle 10 is placed in reverse gear 32 the driver typically would use an accelerator pedal 26 to increase speed to drive to the vehicle 10 and a brake pedal 24 to stop the vehicle when moving in the reverse direction. However, sometimes during back-up operations, the use of two pedals 24, 26 can complicate operation.

In the disclosed system 12, while the vehicle 10 is in reverse gear 32 the acceleration and braking of the vehicle 10 may be controlled using only one of the acceleration pedal 26 and the brake pedal 24. For example, the brake pedal 24 may be used for accelerating and braking the vehicle 10 during the reverse operation. As the driver releases the brake pedal 24 more acceleration is applied to the vehicle 10. When the driver compresses or activates the brake pedal 24 the acceleration is decreased and a braking may be applied. The amount of acceleration and/or braking that is applied may be based upon the position of the brake pedal 24. One skilled in the art would be able to determine what the desirable amount of acceleration and/or braking is for the brake pedal 24 for a particular vehicle 10.

By reducing control of acceleration/braking to a single pedal 24, control can be increased and unwanted reverse acceleration due to body momentum can be eliminated, which can provide enhanced safety and vehicle control.

The vehicle 10 still include both the accelerator pedal 26 and the brake pedal 24 for braking and acceleration control when operating in any of the forward gears of a vehicle transmission. The brake pedal 24 provides an input to a controller 16 to brake the vehicle when the vehicle 10 is one of the plurality of forward gears 30, and the accelerator pedal 26 provides a signal for accelerating the vehicle 10 when the vehicle 10 is one of the plurality of forward gears 30.

The reverse collision avoidance system 12 includes a camera 14 mounted to provide a view of a rear driving direction for the vehicle 10. The camera 14 may be a monocular camera, binocular camera, or another type of sensing device capable of providing a view of the rear travelling path of the vehicle 10. The camera 14 may be mounted in any location that provides a view of the rear driving path of the vehicle 10. A controller 16 may be connected to the camera 14 to analyze the image/data and identify objects 18 within the image that may be obstacles for the vehicle 10. In addition to the camera 14 the collision avoidance system 12 may use other systems and sensors to assist in identifying objects 18. Such systems and sensors may include, but are not limited to: proximity sensors 20, LIDAR, RADAR, ultrasound, GPS 22, radio sensors, etc.

As soon as the vehicle 10 is started and shifted into a reverse gear 32, the backup collision avoidance system 12 is started. A warning is provided to a driver when an obstacle is detected and at least one vehicle collision avoidance action is also provided when the probability that the object is determined to be an obstacle exceeds a predetermined threshold.

An algorithm enabled by the controller 16 minimizes driver intrusion under ordinary circumstances. The algorithm may include a probabilistic analysis of the following elements: sensor-reported objects and pedestrian; expected motion of pedestrians; and expected driver input. Future driver input is unknown, so a range of potential vehicle paths must be calculated. If a vehicle path and pedestrian path (or a static object's position) intersects at some time, a potential collision has been detected. Of all of the potential collisions that are detected, one will require intervention before the others, and that one will be acted upon.

The weight of a collision is a measure of confidence that a potential collision will require intervention. The collision weight directly affects the system's strategy for responding to a potential collision. Modifying our strategy based on our confidence allows us to minimize driver intrusion

In its simplest form, the algorithm provides a prediction of potential collisions and determines confidence that each detected collision will occur that is determined by calculating a corresponding collision weight. The algorithm further provides for the determination of which predicted collision will require intervention first based on the probability and determined collision weight. The system 12 than will determine the optimal braking response for the most relevant collision, given the collision weight and time at which it will occur.

When the reverse collision avoidance system 10 provides a warning to the driver the driver may react quickly by applying the brakes using the single acceleration/braking control pedal 24. Because the driver is using only a single pedal 24 to control reverse operation of the vehicle 10, the driver is always in a proper position to apply the brakes and the reaction time to stop the vehicle 10 may be reduced when compared to similar operation utilizing two pedals to control reverse operation.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A vehicle operating system including an accelerator pedal for generating an input proportional to a desired acceleration of a vehicle when the vehicle is in at least one of a plurality of forward gears and a brake pedal for generating an input for controlling application of vehicle brakes of the vehicle, wherein the vehicle operating system comprises:
a controller configured to receive input from the accelerator pedal and the brake pedal and generating both acceleration commands and braking commands for the vehicle, wherein one of the accelerator pedal and the brake pedal are configured for generating an single input for controlling both acceleration of the vehicle and application of the vehicle brakes when the vehicle is in at least one reverse gear, and the controller is configured to generate both acceleration commands and braking commands responsive to input from the brake pedal when in at least one reverse gear.

2. The vehicle operating system as recited in claim 1, wherein release of the brake pedal provides an input to the controller for accelerating the vehicle at a desired speed.

3. The vehicle operating system as recited in claim 2, wherein application of the brake pedal provides input to the controller that generates commands for reducing acceleration of the vehicle and applying the vehicle brakes.

4. The vehicle operating system as recited in claim 1, wherein input from the accelerator pedal to the controller is not utilized when the vehicle is in the at least one reverse gear.

5. A vehicle comprising:
a transmission having a plurality of forward gears capable of moving the vehicle in a forward direction and at least one reverse gear capable of moving the vehicle in a reverse direction;
an accelerator pedal for applying acceleration to the vehicle when the vehicle is in at least one of the plurality of forward gears;
a brake pedal for applying vehicle brakes to the vehicle when the vehicle is in the at least one reverse gear; and
wherein one of the accelerator pedal and the brake pedal are capable of controlling application of acceleration and vehicle brakes when the transmission is in the at least one reverse gear.

6. The vehicle of claim 5, further comprising a reverse collision avoidance system capable of providing a warning to the driver when an obstacle is detected in the path of the vehicle when the vehicle is in the reverse gear.

7. The vehicle of claim 5, wherein he brake pedal is capable of controlling application of acceleration and the vehicle brakes when the transmission is in the at least one reverse gear.

8. The vehicle as recited in claim 7, including a controller configured to receive input from the accelerator pedal and the brake pedal and generating both acceleration commands and braking commands for the vehicle, wherein the controller is configured to generate both acceleration commands and braking commands responsive to input from the brake pedal when in at least one reverse gear.

9. A method of controlling a vehicle in reverse gear comprising:
braking the vehicle when the driver compresses one of a first and a second pedal in the vehicle when the vehicle is in the reverse gear; and
accelerating the vehicle when the driver releases the one of the first and the second pedal for the vehicle when the vehicle is in the reverse gear.

10. The method as recited in claim 9, including braking the vehicle when the driver compresses the first pedal in the vehicle when the vehicle is in one of a plurality of forward gears and accelerating the vehicle when the driver compresses a second pedal in the vehicle when the vehicle is in one of the plurality of forward gears.

11. The method as recited in claim 9, wherein the one of the first and the second pedal comprises a brake pedal and the method includes ignoring input from an accelerator pedal within when in the reverse gear.

12. The method as recited in claim 9, including a controller configured to receive input from the first pedal and the second pedal and generating both acceleration commands and braking commands for the vehicle, wherein the controller is configured to generate both acceleration commands and braking commands responsive to input from the brake pedal when in at least one reverse gear.

13. The method as recited in claim 12, including accelerating the vehicle to a predetermined speed responsive to commands from a controller when the brake pedal is released and the vehicle is in a reverse gear.

14. A method of claim 9, further comprising:
detecting a plurality of objects proximate to a vehicle with at least one sensor, when the vehicle is placed in a reverse drive gear;
analyzing data from the sensors with a controller for a collision avoidance system to determine if the objects detected are an obstacle for the vehicle;
providing a warning to a driver when an obstacle is detected;
braking the vehicle when the driver compresses a first pedal in the vehicle when the vehicle is in one of a plurality of forward gears;
accelerating the vehicle when the driver compresses a second pedal in the vehicle when the vehicle is in one of the plurality of forward gears;
braking the vehicle when the driver compresses one of the first and the second pedal in the vehicle when the vehicle is in the reverse gear; and
accelerating the vehicle when the driver releases the one of the first and the second pedal for the vehicle when the vehicle is in the reverse gear.
